(19) United States
(12) Patent Application Publication
(10) Pub. No.: US 2025/0066107 A1
(43) Pub. Date: Feb. 27, 2025

(54) PACKAGING BOX WITH CHILD LOCK STRUCTURE

(71) Applicant: KDELTA technology, Shenzhen (CN)

(72) Inventor: Shuanglang WANG, Shenzhen (CN)

(73) Assignee: KDELTA technology, Shenzhen (CN)

(21) Appl. No.: 18/473,183

(22) Filed: Sep. 22, 2023

(30) Foreign Application Priority Data
Aug. 23, 2023 (CN) 202322272767.7

(51) Int. Cl. B65D 85/10; B65D 50/06

(52) U.S. Cl. CPC B65D 85/10; B65D 50/06

(57) ABSTRACT

A packaging box with a child lock structure includes an outer box, an inner box and a lock; the outer box has a box main body and a flip cover, and the box main body has a mounting cavity; the inner box has an accommodating cavity, the inner box is mounted in the mounting cavity, a sliding gap is maintained between the inner box and an inner side wall of the mounting cavity, and the lock is mounted in the sliding gap; and the lock has a locking portion, the lock has a pushing portion, and the outer box is provided with a relief groove corresponding to the pushing portion.

### TECHNICAL FIELD

The present disclosure relates to a packaging box with a child lock structure.

### BACKGROUND

The statements herein merely provide background information related to the present invention and may not necessarily constitute prior art.

An existing packaging box, which takes the form of an inner box and an outer box (such as a cigarette box), wherein the inner box is nested in the outer box, and the outer box also has a flip cover; when it is necessary to take out the articles in the packaging box, the flip cover is opened to take out the articles; at other times, the flip cover is closed to prevent the articles in the packaging box from sliding out, and at the same time, there is a moisture-proof and damp-proof function.

However, the packaging box with such a structure has a disadvantage in that, in particular, it is easy for a user to inadvertently open the flip cover, thereby causing the articles of the packaging box to fall out. Especially for a family with a child at home, the child can easily take out the articles to play, causing unnecessary trouble.

Therefore, a new technical solution needs to be developed to solve the above-mentioned problems.

### SUMMARY

In order to solve the above-mentioned defects and deficiencies of the prior art, the present invention provides a packaging box with a child lock structure, which enables the packaging box has both convenience of use and safety by designing a child lock structure with a simple operation and a clever structure in the packaging box, and the problem that the existing packaging box object easily slides out can be solved; at the same time, the packaging box of the present application also has many advantages, such as low cost, small manufacturing difficulty, suitable for promotion and use, and good aesthetic appearance.

In order to achieve the above object, the present invention adopts the following technical solution: a packaging box with a child lock structure, including an outer box, an inner box and a lock; wherein, the outer box has a box main body and a flip cover connected to an upper side of the box main body, the box main body has a mounting cavity with an opening upwards, and the flip cover is openably and closably arranged at the opening of the mounting cavity.

The inner box has an accommodating cavity with an opening upwards, the inner box is mounted in the mounting cavity, a sliding gap is maintained between the inner box and an inner side wall of the mounting cavity, and the lock can be mounted in a reciprocating manner in the sliding gap; and the lock has a locking portion for limiting opening of the flip cover, the lock further has a pushing portion, and the outer box is provided with a relief groove corresponding to the pushing portion.

In some embodiments, a pushing hole is provided in a rear side face of the box main body.

In some embodiments, the pushing holes are respectively provided in a left side and a right side of the box main body.

In some embodiments, the pushing portion is a pushing hole, and the relief groove is a strip extending up and down.

In some embodiments, an upper side of the box main body is provided with an inclined opening, the inclined opening is an inclined quadrilateral, a rear side edge of the quadrilateral is higher than a front side edge thereof, and the flip cover is rotatably connected to the rear side edge of the quadrilateral.

In some embodiments, the lock has a base plate, a left side plate extending forward from a left side edge of the base plate, and a right side plate extending forward from a right side edge of the base plate, wherein the left side plate and the right side plate form the locking portion, and the pushing portion is provided on the base plate.

In some embodiments, an upper front side of the inner box is provided with a relief notch, and a lower side edge of the relief notch is higher than a front side edge of the inclined opening.

In some embodiments, the outer box is made of paper or plastic or alloy; the inner box is made of paper or plastic or alloy; and the lock is made of paper or plastic or alloy.

In some embodiments, the outer box has a tetragonal structure.

The present invention has obvious advantages and beneficial effects compared with the prior art; in particular, it can be seen from the above-mentioned technical solution that the packaging box has both convenience of use and safety by designing a child lock structure with a simple operation and a clever structure in the packaging box, and the problem that the existing packaging box object easily slides out can be solved; at the same time, the packaging box of the present application also has many advantages, such as low cost, small manufacturing difficulty, suitable for promotion and use, and good aesthetic appearance.

In order to more clearly illustrate the structural features and effects of the present invention, a detailed description of the invention will be given below with reference to the accompanying drawings and specific embodiments.

### BRIEF DESCRIPTION OF DRAWINGS

FIG. 1 is a schematic perspective view of a first embodiment of the present invention;

FIG. 2 is a schematic perspective view of another aspect of the first embodiment of the present invention;

FIG. 3 is an open state view of the first embodiment of the present invention;

FIG. 4 is a schematic exploded view of the first embodiment of the present invention;

FIG. 5 is a front view of the packaging box according to the present invention; A1-A1 line indicates the direction of the cross section.

FIG. 6 is a schematic cross-sectional view of the first embodiment of the present invention (unlocked state);

FIG. 7 is a partially enlarged view of FIG. 6;

FIG. 8 is another schematic cross-sectional view of the first embodiment of the present invention (locked state);

FIG. 9 is a partially enlarged view of FIG. 8;

FIG. 10 is a schematic perspective view of a second embodiment of the present invention; and

FIG. 11 is a schematic exploded view of the second embodiment of the present invention.

### DESCRIPTION OF REFERENCE NUMBERS

10. An outer box; 11. a box main body; 111. a mounting cavity; 112. a sliding gap; 12. a flip cover; 13. a relief groove; 14. an inclined opening; 20. an inner box; 21. an accommodating cavity; 22. a relief notch; 30. a lock; 301. a base plate; 302. a left side plate; 303. a right side plate; 31. a locking portion; and 32. a pushing portion.

### DETAILED DESCRIPTION OF THE EMBODIMENTS

The technical solutions in the embodiments of the present invention will be clearly and completely described below with reference to the accompanying drawings, and it is to be understood that the described embodiments are merely preferred embodiments of the present invention.

It will be understood that when an element is referred to as being ‘fixed’ to another element, it can be directly on the other element or intervening elements may also be present. When an element is referred to as being ‘connected’ to another element, it can be directly connected to the other element or intervening elements may also be present. As used herein, the terms ‘vertical’, ‘horizontal’, ‘left’, ‘right’, and the like are used for descriptive purposes only and are not intended to be exclusive embodiments.

Unless defined otherwise, all technical and scientific terms used herein have the same meaning as commonly understood by one of ordinary skill in the art to which this invention belongs. The terminology used herein in the description of the invention is for the purpose of describing particular embodiments only and is not intended to be limiting of the invention. As used herein, the term ‘and/or’ includes any and all combinations of one or more of the associated listed items.

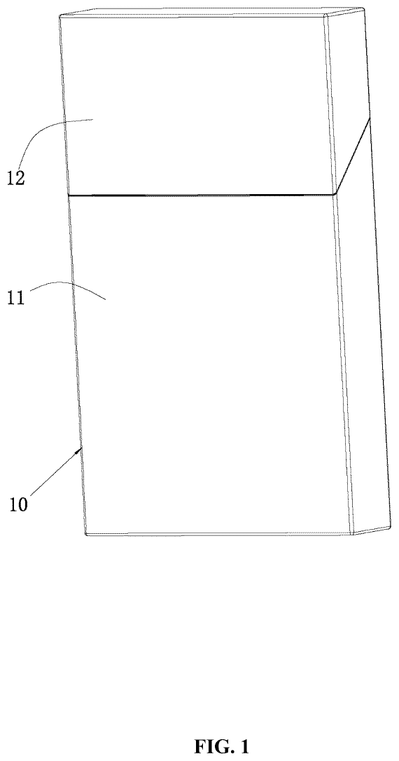

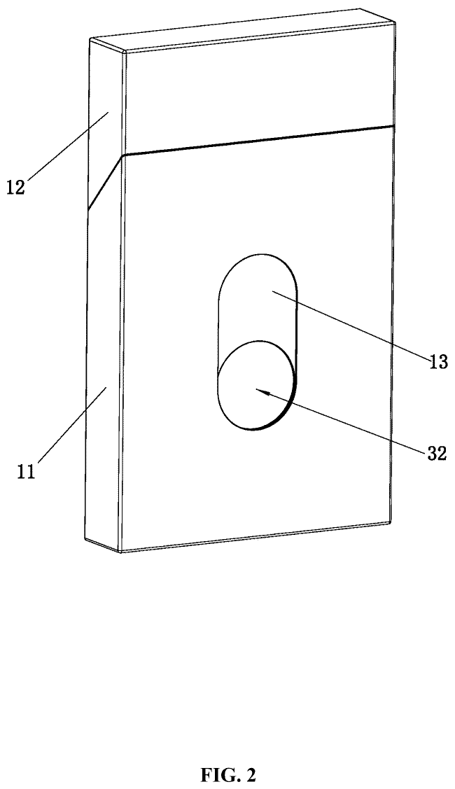

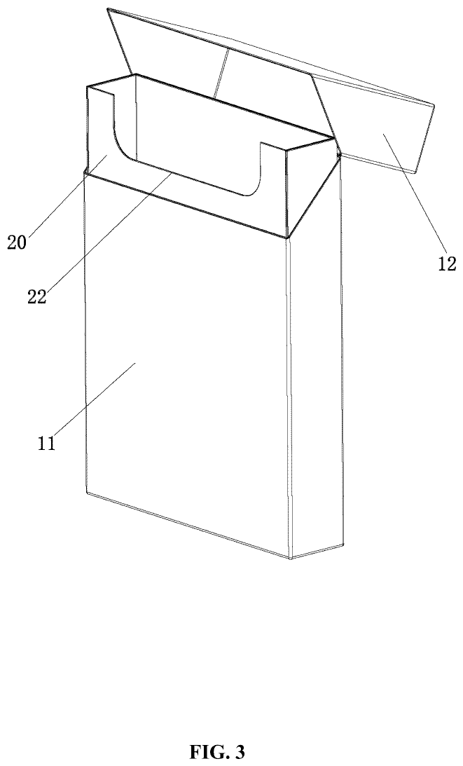

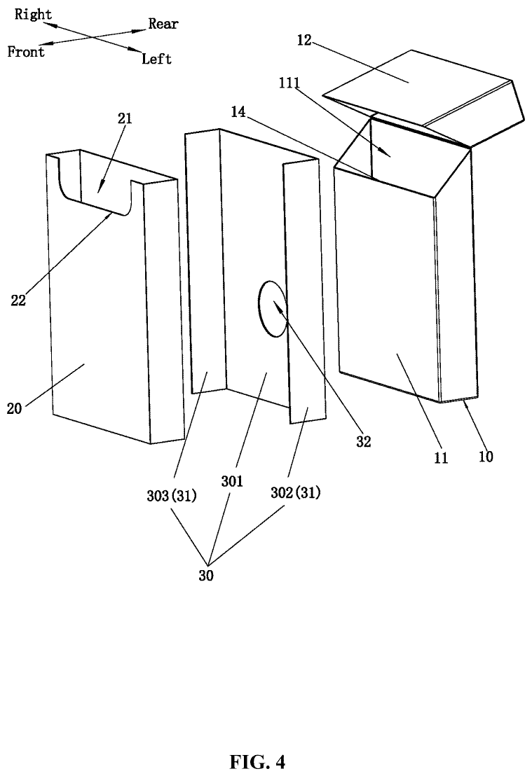

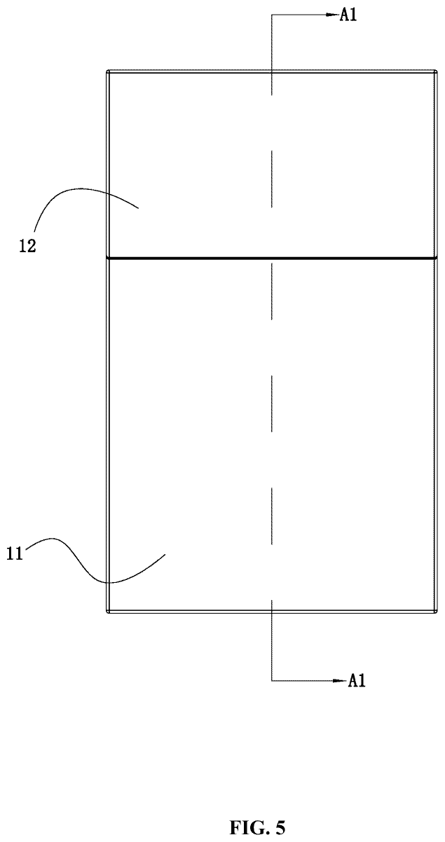

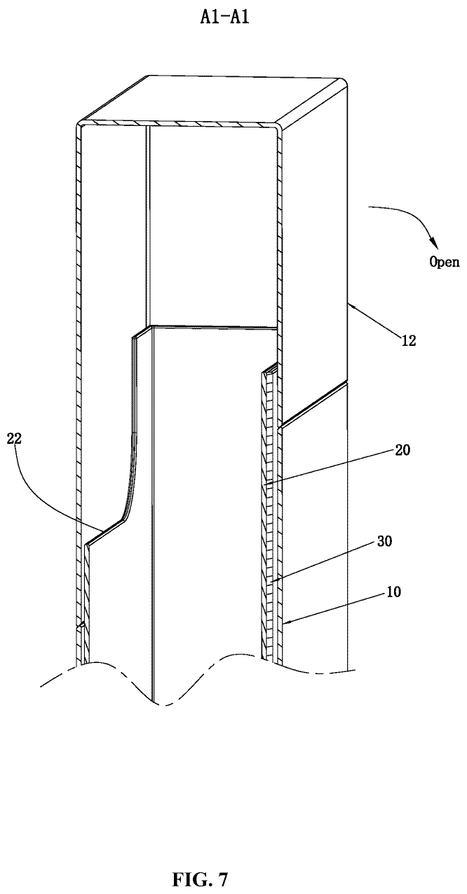

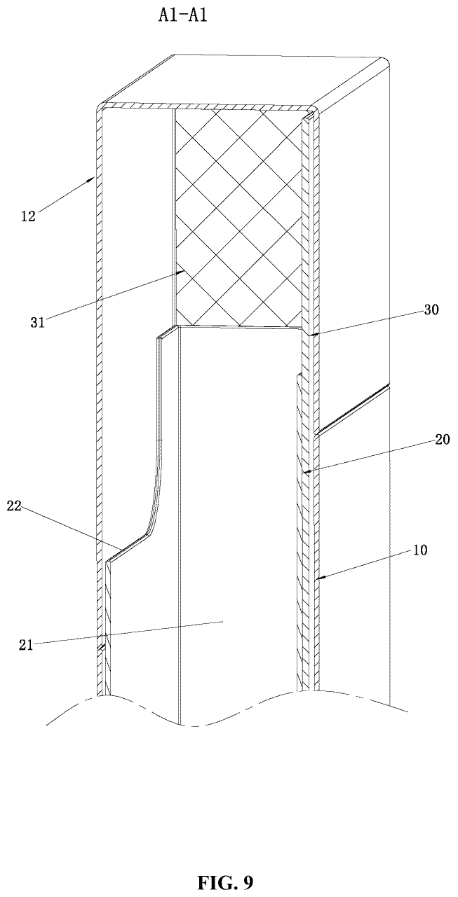

Referring to FIGS. 1 to 11, a packaging box with a child lock structure according to an embodiment of the present invention includes an outer box 10, an inner box 20, and a lock 30. The outer box 10 has a box main body 11 and a flip cover 12 connected to the upper side of the box main body 11, the box main body 11 has a mounting cavity 111 with an opening upwards, and the flip cover 12 is openably and closably arranged at the opening of the mounting cavity 111.

The inner box 20 has an accommodating cavity 21 with an opening upwards, the inner box 20 is mounted on the mounting cavity 111, a sliding gap 112 is maintained between the inner box 20 and an inner side wall of the mounting cavity 111, and the lock 30 can be mounted in a reciprocating manner in the sliding gap 112; and the lock 30 has a locking portion 31 for limiting opening of the flip cover 12, the lock 30 also has a pushing portion 32, and the outer box 10 is provided with a relief groove 13 corresponding to the pushing portion 32.

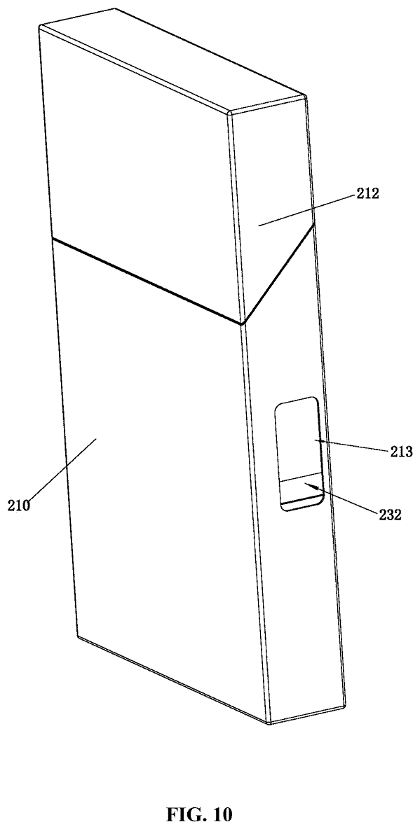

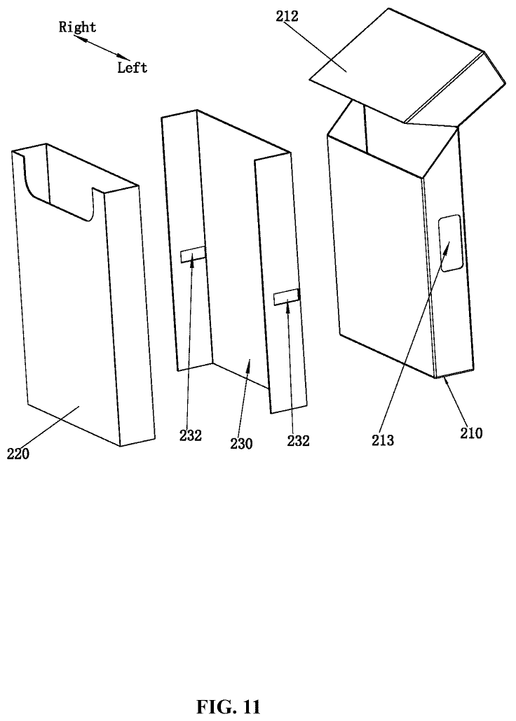

Specifically, the pushing portion 32 is a pushing hole, and is preferably a circular hole; however, the pushing portion 32 may also be a semi-circular hole, a rectangular hole or other irregular shapes, and is not particularly limited herein; the relief groove 13 is a strip extending up and down. As shown in FIGS. 1 to 9, the pushing hole 32 may be provided in a rear side face of the box main body 11. In another embodiments, as shown in FIGS. 10-11, the packaging box includes an outer box 210, an inner box 220, and a lock 230. The outer box 210 has a box main body 11 (same to the counterparts in FIGS. 1-9) and a flip cover 212 connected to the upper side of the box main body 11. The box main body 11 has a mounting cavity 111 (same to the counterparts in FIGS. 1-9) with an opening upwards, and the flip cover 12 is openably and closably arranged at the opening of the mounting cavity 111. The inner box 220 has an accommodating cavity 21 (same to the counterparts in FIGS. 1-9) with an opening upwards, the inner box 220 is mounted on the mounting cavity 111. A sliding gap 112 (same to the counterparts in FIGS. 1-9) is maintained between the inner box 220 and an inner side wall of the mounting cavity 111. The lock 230 can be mounted in a reciprocating manner in the sliding gap 112. The lock 230 has a locking portion 31 (same to the counterparts in FIGS. 1-9) for limiting opening of the flip cover 212. The lock 230 also has two pushing portions 232, and the outer box 10 is provided with two relief grooves 213 corresponding to the pushing portions 232. The pushing portions 232 may be respectively provided in a left side and a right side of the box main body 11, so that the convenience of unlocking and locking and the reliability of stability can be ensured.

Furthermore, the upper side of the box main body 11 is provided with an inclined opening 14, the inclined opening 14 is an inclined quadrilateral, the rear side edge of the quadrilateral is higher than the front side edge thereof, and the flip cover 12 is rotatably connected to the rear side edge of the quadrilateral, and the rotational connection method thereof may be an indentation or a structure such as a rotary shaft; here, it should be noted that the opening of the upper side of the box main body 11 is an inclined opening, but as a preferred embodiment, it may also be a flat opening arrangement, i.e. a horizontally arranged quadrilateral in practical use.

The lock 30 has a base plate 301, a left side plate 302 extending forward from a left side edge of the base plate 301, and a right side plate 303 extending forward from a right side edge of the base plate 301, wherein the left side plate 302 and an upper portion of the right side plate 303 form the locking portion 31, and the pushing portion 32 is provided on the base plate 301.

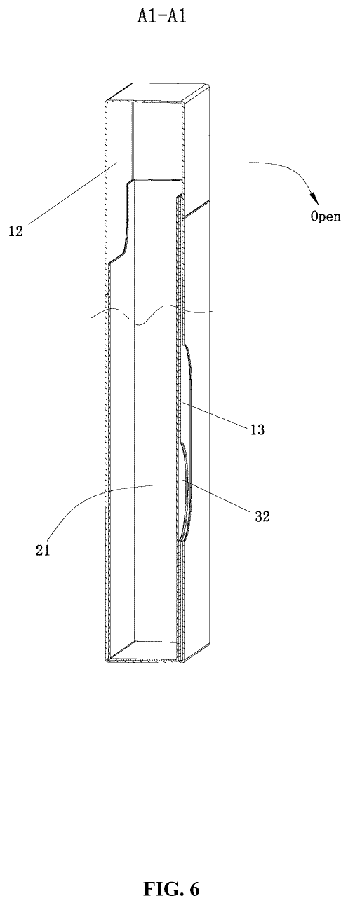

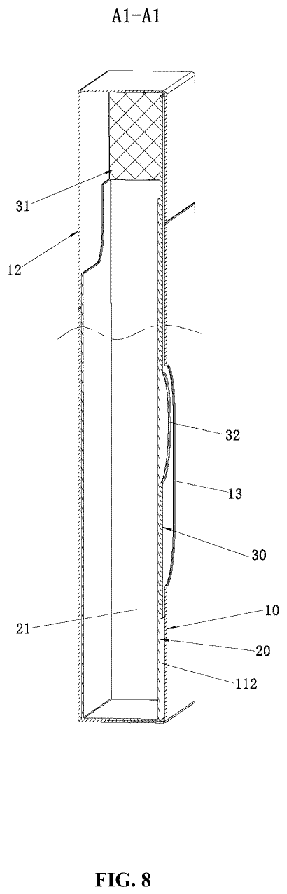

With reference to FIGS. 6-9, in practical applications, in the unlocked state of FIG. 6, the lock 30 is pushed to move upwards via the push hole so as to enable the lock 30 to go to the locked state of FIG. 8, and at this time, the left side plate 302 and the right side plate 303 of the lock 30 restrict the flip cover 12 from rotating back to open, so that the flip cover 12 cannot be opened and locking is achieved.

When unlocking is required, the lock 30 is pushed to move downwards via the push hole, so that the lock 30 returns to the state of FIG. 6, and at this time, the left side plate 302 and the right side plate 303 of the lock 30 release the turning restriction of the flip cover 12, and at this time, the flip cover 12 can be opened to complete unlocking.

The upper front side of the inner box 20 is provided with a relief notch 22, so that a user can conveniently remove an article, especially a strip-shaped article (such as a cigarette, a strip-shaped snack, a strip-shaped tool, etc.) from the inner box 20, and the lower side edge of the relief notch 22 is higher than the front side edge of the inclined opening 14.

In practical applications, the outer box 10 is made of paper or plastic or alloy; the inner box 20 is made of paper or plastic or alloy; the lock 30 is made of paper or plastic or alloy. Generally, the outer box 10 has a tetragonal structure, and the inner box 20 also has an adapted tetragonal structure.

The design of the present invention is focused on that the packaging box has both convenience of use and safety by designing a child lock structure with a simple operation and a clever structure in the packaging box, and the problem that the existing packaging box object easily slides out can be solved; at the same time, the packaging box of the present application also has many advantages, such as low cost, small manufacturing difficulty, suitable for promotion and use, and good aesthetic appearance.

The above description is only a preferred embodiment of the present invention, and is not intended to limit the technical scope of the present invention, so that any minor modifications, equivalent changes and modifications made to the above embodiment according to the technical spirit of the present invention are within the technical scope of the present invention.

1. A packaging box with a child lock structure, comprising an outer box, an inner box and a lock; wherein, the outer box has a box main body and a flip cover connected to an upper side of the box main body, the box main body has a mounting cavity with an outer box opening upwards, and the flip cover is openably and closably arranged at the outer box opening of the mounting cavity;
the inner box has an accommodating cavity with an inner box opening upwards, the inner box is mounted in the mounting cavity of box main body, forming a sliding gap between the inner box and an inner side wall of the mounting cavity of the outer box; the lock is mounted in a reciprocating manner in the sliding gap; and
the lock has a locking portion for limiting opening of the flip cover, the lock further has a pushing portion, and the outer box is provided with at least one relief groove corresponding to the pushing portion;
the lock is consisted of a base plate, a left side plate extending forward from a left side edge of the base plate, and a right side plate extending forward from a right side edge of the base plate; wherein the left side plate and the right side plate are the locking portion, and the pushing portion is provided on the base plate;
the base plate is parallel to a rear wall of the inner box, and the left side plate and the right side plate are parallel to side walls of the inner box, so that the lock is movable relative to both the inner box and the outer box.

2. (canceled)

3. The packaging box with the child lock structure according to claim 1, wherein, the pushing portion of the lock are pushing holes respectively provided on a left side and a right side of the lock; the number of the at least one relief groove is two, and the two relief grooves are arranged along a left longitudinal surface and a right longitudinal surface of the box main body, respectively.

4. The packaging box with the child lock structure according to claim 1, wherein, the pushing portion is a pushing hole located on the lock, allowing user's fingertip to be placed; the corresponding relief groove is arranged along a rear longitudinal surface of the outer box.

5. The packaging box with the child lock structure according to claim 4, wherein, the upper side of the box main body is provided with the outer box opening; the outer box opening is an inclined opening; the inclined opening is an inclined quadrilateral, a rear side edge of the quadrilateral is higher than a front side edge thereof, and the flip cover is rotatably connected to the rear side edge of the quadrilateral.

6. (canceled)

7. The packaging box with the child lock structure according to claim 5, wherein, an upper front side of the inner box is provided with a relief notch, and a lower side edge of the relief notch is higher than a front side edge of the inclined opening.

8. The packaging box with the child lock structure according to claim 5, wherein, the outer box is made of paper or plastic or alloy; the inner box is made of paper or plastic or alloy; and the lock is made of paper or plastic or alloy.

9. The packaging box with the child lock structure according to claim 8, wherein, the outer box has a tetragonal structure.
